(19) United States
(12) Patent Application Publication
(10) Pub. No.: US 2019/0202082 A1
(43) Pub. Date: Jul. 4, 2019

(54) PVC VENEER-OVERLAID PLYWOOD AND MANUFACTURING METHOD THEREOF

(71) Applicant: Mengqi ZHANG, Dongguan City (CN)

(72) Inventor: Mengqi ZHANG, Dongguan City (CN)

(21) Appl. No.: 15/906,120

(22) Filed: Feb. 27, 2018

(30) Foreign Application Priority Data
Dec. 30, 2017 (CN) 201711488705.2

(51) Int. Cl. B27D 1/08; C08J 5/12; C08J 7/04; B32B 21/02; B32B 21/14; B32B 27/30; B27N 7/00

(52) U.S. Cl. CPC B27D 1/08; B32B 2307/72; C08J 7/047; B32B 21/02; B32B 21/14; B32B 27/304; B27N 7/005; C08J 2327/06; C08J 2433/14; C08J 2427/06; B32B 2250/02; B32B 2255/10; B32B 2317/16; B32B 2327/06; B32B 2479/00; C08J 5/12

(57) ABSTRACT

A PVC veneer-overlaid plywood and a manufacturing method thereof. The PVC veneer-overlaid plywood includes a medium-and-high-density fiberboard, a PVC membrane and an ultraviolet paint. A hard, wear-resistant and highly transparent film will be formed after the ultraviolet paint sprayed on the PVC membrane is cured by ultraviolet light, so that the scratch-resistant, scratch-preventing, heat-resistant and durable effect is realized. In addition, the cured ultraviolet paint is stable in color; the flat mirror effect is better; and the paint film is full and free from wrinkles, so that the color uniformity of the surface of the coated film is effectively increased. It is convenient and quick to coat the surface of the plywood with the PVC membrane. The ultraviolet paint is high in coating efficiency, is low in coating cost, and is environmentally friendly.

### FIELD OF THE INVENTION

The present invention relates to the technical field of plywood, in particular to, a PVC veneer-overlaid plywood and a manufacturing method thereof.

### BACKGROUND OF THE INVENTION

As an important wood engineering material, plywood is widely applied to construction, home furniture and other related fields by virtue of its advantages of high strength, good dimensional stability, excellent processing property, etc. In order to make the plywood more beautiful and practical, generally, the surface of the plywood may be coated with a wood veneer, a PVC membrane, or other materials. If the wood veneer is selected for coating, the surface of a common wood veneer is unpainted. After the coating is completed, it also needs lots of labor to sand and paint the plywood. In addition, this plywood is likely to blister and delaminate. If the PVC membrane is selected for coating, the operation is relatively convenient. However, the veneered plywood does not have the properties of high hardness, scratch resistance, scratch prevention or heat resistance, and thus is poor in durability during transportation and use.

### SUMMARY OF THE INVENTION

In order to solve the above problems, the present invention provides a more beautiful and durable PVC veneer-overlaid plywood.

A PVC veneer-overlaid plywood comprises a medium-and-high-density fiberboard, a PVC membrane and an ultraviolet paint, wherein the PVC membrane is arranged on the surface of the medium-and-high-density fiberboard, and the ultraviolet paint is painted on the surface of the PVC membrane.

In the above technical solution, the density of the medium-and-high-density fiberboard is 500-880 kg/m³.

In the above technical solution, the size of the medium-and-high-density fiberboard does not exceed 1220 mm*2440 mm

In the above technical solution, the PVC membrane comprises the following components in parts by weight: 72-77.5 parts of polyvinyl chloride (PVC), 1-2 parts of epoxidized soybean oil, 13-18 parts of dioctyl terephthalate, 1-2 parts of a stabilizer, and 5.5-7.5 parts of toner. The epoxidized soybean oil and the dioctyl terephthalate are used as plasticizers to enhance the flexibility of the PVC membrane so as to facilitate processing. Using zinc stearate or barium stearate as the stabilizer can obtain excellent coloring and anti-scaling effect, and can improve the weatherability. The toner may be configured to adjust the color of the PVC membrane.

In the above technical solution, the stabilizer adopts zinc stearate or barium stearate.

In the above technical solution, the ultraviolet paint comprises the following components in parts by weight: 15-20 parts of amino acrylic resin, 25-35 parts of polyurethane acrylic resin, 15-25 parts of trimethylolpropane triacrylate, 15-25 parts of tri(propyleneglycol) diacrylate, 4-8 parts of a photosensitizer, 3-7 parts of matte powder, and 1-3 parts of quartz powder. The amino acrylic resin and the polyurethane acrylic resin are used as base materials. The trimethylolpropane triacrylate and the tri(propyleneglycol) diacrylate are used as active diluents to reduce the viscosity of the paint and cure the paint to form a membrane. The photosensitizer is configured to improve the photosensitive property of the paint. The matte powder is configured to realize delustering of the paint. The quartz powder is used as a filler to improve the weatherability of the paint.

The present invention further provides a method for preparing a PVC veneer-overlaid plywood. The method comprises the following steps: step A, processing and shaping a medium-and-high-density fiberboard according to a requirement of a product; step B, adhering the surface of the medium-and-high-density fiberboard to a PVC membrane through gluing; step C, coating the surface of the PVC membrane with an ultraviolet paint after the medium-and-high-density fiberboard and the PVC membrane are glued; and step D, drying a plywood coated with the ultraviolet paint through an ultraviolet dryer, fixing the dried plywood, and transporting the fixed and dried plywood.

In the above technical solution, the gluing manner in step B comprises plane gluing and plastic-absorbing gluing.

In the above technical solution, the coating manner of the ultraviolet paint in step C comprises a roll coating manner, a shower coating manner and a spray coating manner.

In the above technical solution, when the ultraviolet paint is applied onto the PVC membrane through the shower coating manner or the spray coating manner, a rest of 3-4 minutes is needed before the next step is carried out.

The present invention has the following advantageous effects.

1. A hard, wear-resistant and highly transparent film will be formed after the ultraviolet paint sprayed on the PVC membrane is cured by ultraviolet light, so that the scratch-resistant, scratch-preventing heat-resistant and durable effect is realized.

2. Through curing by the strong ultraviolet light, the plywood is stable in color and everlastingly new, so that the problems of color fading and color difference are effectively solved. The flat mirror effect is better, and the paint film is full and free from wrinkles, so that the color uniformity of the surface of the coated film is effectively increased.

3. It is convenient and quick to coat the surface of the plywood with the PVC membrane. Different patterns may be selected to make the plywood more beautiful. The efficiency of coating the PVC membrane with the ultraviolet paint is as high as tens of times of the conventional coating efficiency; and this coating cost is as low as a half of the conventional coating cost.

4. The UV paint is environment-friendly, and does not contain any volatile substances, so that a product produced by using this ultraviolet paint is safe and environmentally friendly.

### BRIEF DESCRIPTION OF THE FIGURES

FIG. 1 is a schematically structural view of a PVC veneer-overlaid plywood;

FIG. 2 is a step flow chart of a method for preparing the PVC veneer-overlaid plywood;

FIG. 3 is another step flow chart of the method for preparing the PVC veneer-overlaid plywood; and

FIG. 4 is yet another step flow chart of the method for preparing the PVC veneer-overlaid plywood.

Description of the reference numerals in the figures: 1, medium-and-high-density fiberboard; 2, PVC membrane; and 3, ultraviolet paint.

### DETAILED DESCRIPTION OF THE EMBODIMENTS

To further illustrate the above objects, technical solutions and effects of the present invention, the present invention will be described below through embodiments in combination with the accompanying drawings and related well-known technical means.

### Embodiment 1

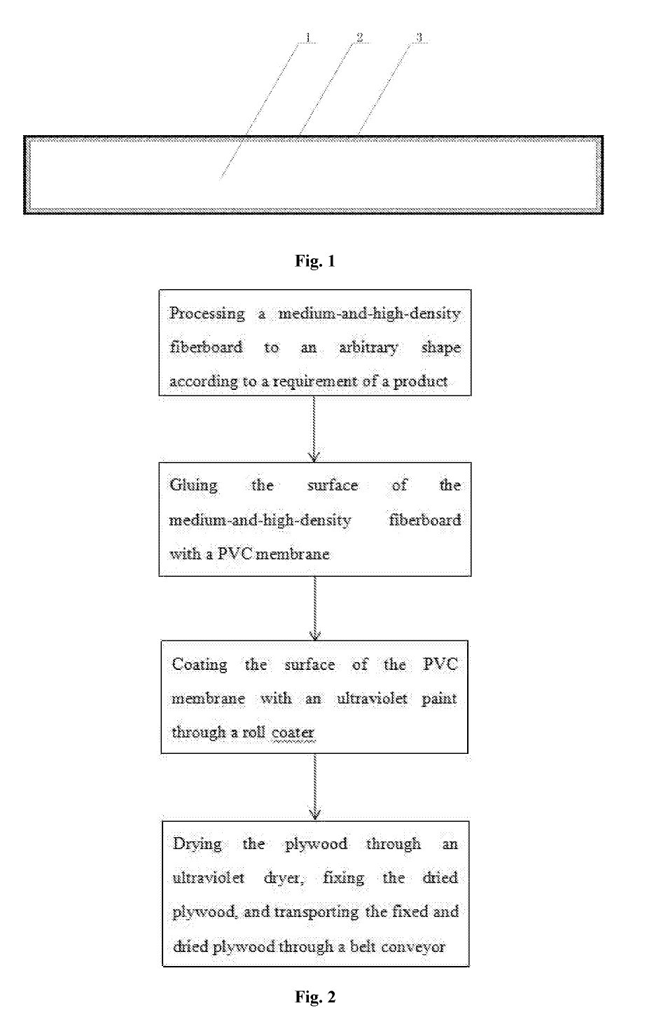

As shown in FIG. 1, a PVC veneer-overlaid plywood comprises a medium-and-high-density fiberboard 1, a PVC membrane 2 and an ultraviolet paint 3, wherein the PVC membrane 2 is arranged on the surface of the medium-and-high-density fiberboard 1, and the ultraviolet paint 3 is painted on the surface of the PVC membrane 2.

The density of the medium-and-high-density fiberboard 1 is 500 kg/m³.

The size of the medium-and-high-density fiberboard 1 is 500 mm*1000 mm

The PVC membrane 2 comprises the following components in parts by weight: 72 parts of PVC, 1 part of epoxidized soybean oil, 13 parts of dioctyl terephthalate, 1 part of zinc stearate, and 5.5 parts of toner. The epoxidized soybean oil and the dioctyl terephthalate are used as plasticizers to enhance the flexibility of the PVC membrane so as to facilitate processing. The zinc stearate as a stabilizer can obtain excellent coloring and anti-scaling effect, and can improve the weatherability. The toner may be configured to adjust the color of the PVC membrane.

The ultraviolet paint 3 comprises the following components in parts by weight: 15 parts of amino acrylic resin, 25 parts of polyurethane acrylic resin, 15 parts of trimethylolpropane triacrylate, 15 parts of tri(propyleneglycol) diacrylate, 4 parts of a photosensitizer, 3 parts of matte powder, and 1 part of quartz powder. The amino acrylic resin and the polyurethane acrylic resin are used as base materials. The trimethylolpropane triacrylate and the tri(propyleneglycol) diacrylate are used as active diluents to reduce the viscosity of the paint and cure the paint to form a membrane. The photosensitizer is configured to improve the photosensitive property of the paint. The matte powder is configured to realize delustering of the paint. The quartz powder is used as a filler to improve the weatherability of the paint.

As shown in FIG. 2, a method for preparing a PVC veneer-overlaid plywood comprises the following steps: step A, processing and shaping a medium-and-high-density fiberboard 1 according to a requirement of a product; step B, gluing the surface of the medium-and-high-density fiberboard 1 with a PVC membrane 2; step C, coating the surface of the PVC membrane 2 with an ultraviolet paint through a roll coater after the medium-and-high-density fiberboard 1 and the PVC membrane 2 are glued; and step D, drying a plywood coated with the UV paint 3 through an ultraviolet dryer, fixing the dried plywood, and transporting the fixed and dried plywood through a belt conveyor.

### Embodiment 2

As shown in FIG. 1, a PVC veneer-overlaid plywood comprises a medium-and-high-density fiberboard 1, a PVC membrane 2 and an ultraviolet paint 3, wherein the PVC membrane 2 is arranged on the surface of the medium-and-high-density fiberboard 1; and the ultraviolet paint 3 is painted on the surface of the PVC membrane 2.

The density of the medium-and-high-density fiberboard 1 is 600 kg/m³.

The size of the medium-and-high-density fiberboard 1 is 800 mm*1500 mm

The PVC membrane 2 comprises the following components in parts by weight: 75 parts of PVC, 1.5 parts of epoxidized soybean oil, 15 parts of dioctyl terephthalate, 2 parts of zinc stearate, and 6.5 parts of toner. The epoxidized soybean oil and the dioctyl terephthalate are used as plasticizers to enhance the flexibility of the PVC membrane so as to facilitate processing. The zinc stearate as a stabilizer can obtain excellent coloring and anti-scaling effect, and can improve the weatherability. The toner may be configured to adjust the color of the PVC membrane.

The ultraviolet paint 3 comprises the following components in parts by weight: 17 parts of amino acrylic resin, 30 parts of polyurethane acrylic resin, 20 parts of trimethylolpropane triacrylate, 20 parts of tri(propyleneglycol) diacrylate, 6 parts of a photosensitizer, 5 parts of matte powder, and 2 parts of quartz powder. The amino acrylic resin and the polyurethane acrylic resin are used as base materials. The trimethylolpropane triacrylate and the tri(propyleneglycol) diacrylate are used as active diluents to reduce the viscosity of the paint and cure the paint to form a membrane. The photosensitizer is configured to improve the photosensitive property of the paint. The matte powder is configured to realize delustering of the paint. The quartz powder is used as a filler to improve the weatherability of the paint.

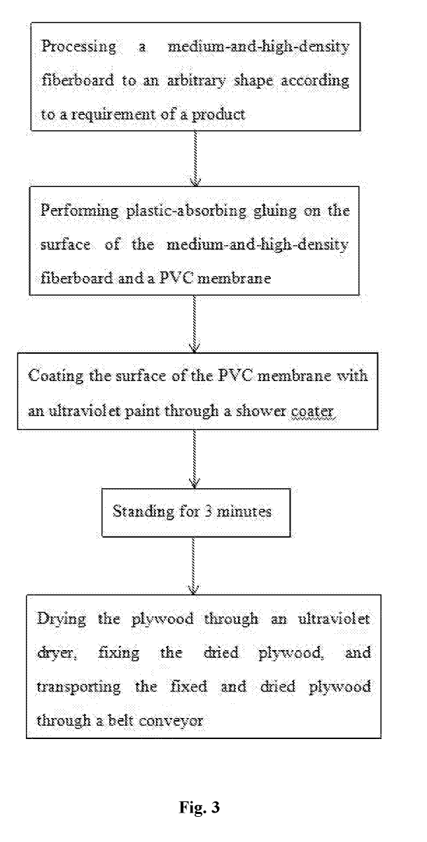

As shown in FIG. 3, a method for preparing a PVC veneer-overlaid plywood comprises the following steps: step A, processing a medium-and-high-density fiberboard 1 to an arbitrary shape according to a requirement of a product; step B, performing plastic-absorbing gluing on the surface of the medium-and-high-density fiberboard 1 and a PVC membrane 2; step C, coating the surface of the PVC membrane 2 with an ultraviolet paint 3 through a shower coater after the medium-and-high-density fiberboard 1 and the PVC membrane 2 are glued, and then standing for 3 minutes; and step D, drying a plywood coated with the ultraviolet paint 3 through an ultraviolet dryer, fixing the dried plywood, and transporting the fixed and dried plywood through a belt conveyor.

### Embodiment 3

As shown in FIG. 1, a PVC veneer-overlaid plywood comprises a medium-and-high-density fiberboard 1, a PVC membrane 2 and an ultraviolet paint 3, wherein the PVC membrane 2 is arranged on the surface of the medium-and-high-density fiberboard 1; and the ultraviolet paint 3 is painted on the surface of the PVC membrane 2.

The density of the medium-and-high-density fiberboard 1 is 880 kg/m³.

The size of the medium-and-high-density fiberboard 1 is 1220 mm*2440 mm

The PVC membrane 2 comprises the following components in parts by weight: 77.5 parts of PVC, 2 parts of epoxidized soybean oil, 18 parts of dioctyl terephthalate, 2 parts of barium stearate, and 5.5 parts of toner. The epoxidized soybean oil and the dioctyl terephthalate are used as plasticizers to enhance the flexibility of the PVC membrane so as to facilitate processing. The barium stearate as a stabilizer can obtain excellent coloring and anti-scaling effect, and can improve the weatherability. The toner may be configured to adjust the color of the PVC membrane.

The ultraviolet paint 3 comprises the following components in parts by weight: 20 parts of amino acrylic resin, 35 parts of polyurethane acrylic resin, 25 parts of trimethylolpropane triacrylate, 25 parts of tri(propyleneglycol) diacrylate, 8 parts of a photosensitizer, 7 parts of matte powder, and 3 parts of quartz powder. The amino acrylic resin and the polyurethane acrylic resin are used as base materials. The trimethylolpropane triacrylate and the tri(propyleneglycol) diacrylate are used as active diluents to reduce the viscosity of the paint and cure the paint to form a membrane. The photosensitizer is configured to improve the photosensitive property of the paint. The matte powder is configured to realize delustering of the paint. The quartz powder is used as a filler to improve the weatherability of the paint.

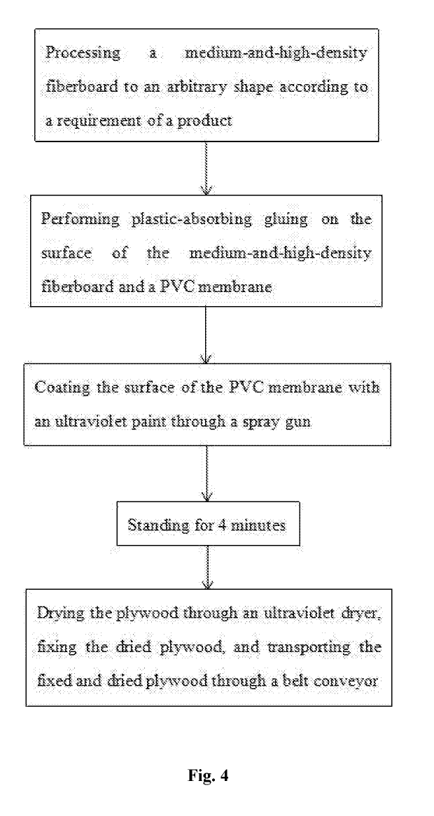

As shown in FIG. 4, a method for preparing a PVC veneer-overlaid plywood comprises the following steps: step A, processing a medium-and-high-density fiberboard 1 to an arbitrary shape according to a requirement of a product; step B, performing plastic-absorbing gluing on the surface of the medium-and-high-density fiberboard 1 and a PVC membrane 2; step C, coating the surface of the PVC membrane 2 with an ultraviolet paint 3 through a spray gun after the medium-and-high-density fiberboard 1 and the PVC membrane 2 are glued, and then standing for 4 minutes; and step D, drying a plywood coated with the ultraviolet paint 3 through an ultraviolet dryer, fixing the dried plywood, and transporting the fixed and dried plywood through a belt conveyor.

The following performance tests are performed on a PVC veneer-overlaid plywood and the PVC veneer-overlaid plywood coated with the ultraviolet paint, which is prepared in Embodiment 2. The results are shown in Table 1 below.

Test Items

1. Determination of Film Hardness by Pencil Test (Pencil Hardness)

Pencil requirements are as follows. Select a group of Chung Hwa drawing pencils marked as 6H, 5H, 4H, 3H, 2H, 1H, F, HB, B, 2B, 3B, 4B, 5B and 6B whose hardness decrease gradually from 6H to 6B. The pencils are sharpened to expose 5 mm-6 mm of pencil leads. Each pencil tip is ground in a manner that there is a 90-degree angle between the pencil tip and a plane of a piece of sandpaper till the tip end becomes flat and the tip edge is sharp. No breakage or notch on the edge of the pencil tip is allowed.

The test method comprises the following procedures. The test is performed first using the hardest pencil. This pencil is installed on a pencil hardness tester; the balance is realized after adjustments; 1 kg of load is added; and the pencil is held against the horizontal plane at an angle of 45±1 degrees. A coated surface of a sample is horizontally placed upwards and fixed. The advance speed and the advance distance of the pencil are 1 mm/s and 3 mm, respectively. The thrust maintains uniform, and shall not break the pencil lead. Each pencil lead scratches 5 lines on the coated surface. The test is finished till the pencil whose lead cannot scratch the coated surface is found.

Note: The pencil should be rotated by 90 degrees every time scratching is completed, so as to avoid a worn area of the pencil tip. Otherwise, the test result is invalid.

2. Test of Physical and Chemical Properties of Surface Coating of Furniture-Part 8-Determination of Wearability

A test piece is fixed on the working plate of an abrasion tester; and a weight of 1000±1 g and a rubber wheel conforming to the requirements are placed on the surface of the test piece through a pressurizing arm. A dust removal device is started during the test, and the normal operation of the dust removal device is ensured. The test piece grinds the surface of a coating by 50r first to form a smooth and even worn ring on the surface of the coating. The test piece should be replaced in time once uneven wearing appears. A calculator is readjusted to a specified grinding time, and a worn degree on the surface of the coating is observed.

TABLE 1
Property Test Result

| | PVC veneer-overlaid | |
|---|---|---|
| | plywood coated with | PVC veneer-overlaid |
| | ultraviolet paint | plywood |
| Determination of film | 6 H | 2 H |
| hardness by pencil test | | |
| Determination of | 10000 r | 3000 r |
| wearability | | |

The foregoing embodiments are merely intended to illustrate but not to limit the present invention. Thus, all equivalent changes or modifications made according to the method described by the present invention shall fall within the scope of the present invention.

What is claimed is:

1. A PVC veneer-overlaid plywood, comprising: a medium-and-high-density fiberboard, a PVC membrane and an ultraviolet paint, wherein the PVC membrane is arranged on the surface of the medium-and-high-density fiberboard, and the UV paint is painted on the surface of the PVC membrane.

2. The PVC veneer-overlaid plywood of claim 1, wherein the density of the medium-and-high-density fiberboard is 500-880 kg/m³.

3. The PVC veneer-overlaid plywood of claim 1, wherein the size of the medium-and-high-density fiberboard does not exceed 1220 mm*2440 mm

4. The PVC veneer-overlaid plywood of claim 2, wherein the size of the medium-and-high-density fiberboard does not exceed 1220 mm*2440 mm

5. The PVC veneer-overlaid plywood of claim 1, wherein the PVC membrane comprises the following components in parts by weight: 72-77.5 parts of polyvinyl chloride, 1-2 parts of epoxidized soybean oil, 13-18 parts of dioctyl terephthalate, 1-2 parts of a stabilizer, and 5.5-7.5 parts of toner.

6. The PVC veneer-overlaid plywood of claim 2, wherein the PVC membrane comprises the following components in parts by weight: 72-77.5 parts of polyvinyl chloride, 1-2 parts of epoxidized soybean oil, 13-18 parts of dioctyl terephthalate, 1-2 parts of a stabilizer, and 5.5-7.5 parts of toner.

7. The PVC veneer-overlaid plywood of claim 5, wherein zinc stearate or barium stearate is used as the stabilizer.

8. The PVC veneer-overlaid plywood of claim 6, wherein zinc stearate or barium stearate is used as the stabilizer.

9. The PVC veneer-overlaid plywood of claim 1, wherein the UV paint comprises the following components in parts by weight: 15-20 parts of amino acrylic resin, 25-35 parts of polyurethane acrylic resin, 15-25 parts of trimethylolpropane triacrylate, 15-25 parts of tri(propyleneglycol) diacrylate, 4-8 parts of a photosensitizer, 3-7 parts of matte powder, and 1-3 parts of quartz powder.

10. A method for preparing the PVC veneer-overlaid plywood of claim 1, the method comprising the following steps:
step A, processing and shaping a medium-and-high-density fiberboard according to a requirement of a product;
step B, adhering the surface of the medium-and-high-density fiberboard to a PVC membrane through gluing;
step C, coating the surface of the PVC membrane with an ultraviolet paint after the medium-and-high-density fiberboard and the PVC membrane are glued; and
step D, drying a plywood coated with the ultraviolet paint through an ultraviolet dryer, fixing the dried plywood, and transporting the fixed and dried plywood through a belt conveyor.

11. The method of claim 10, wherein the gluing manner in step B comprises plane gluing and plastic-absorbing gluing.

12. The method of claim 10, wherein the coating manner of the ultraviolet paint in step C comprises a roll coating manner, a shower coating manner and a spray coating manner.

13. The method of claim 12, wherein when the ultraviolet paint is applied onto the PVC membrane through the shower coating manner or the spray coating manner, a rest of 3-4 minutes is needed before the next step is carried out.
